(19) United States
(12) Patent Application Publication
(10) Pub. No.: US 2016/0309205 A1
(43) Pub. Date: Oct. 20, 2016

(54) SYSTEM AND METHOD FOR TRANSMITTING DIGITAL AUDIO STREAMS TO ATTENDEES AND RECORDING VIDEO AT PUBLIC EVENTS

(71) Applicant: Bryan John Cowger, Meadow Vista, CA (US)

(72) Inventor: Bryan John Cowger, Meadow Vista, CA (US)

(21) Appl. No.: 15/163,559

(22) Filed: May 24, 2016

Related U.S. Application Data
(63) Continuation-in-part of application No. 15/096,092, filed on Apr. 11, 2016.
(60) Provisional application No. 62/148,002, filed on Apr. 15, 2015.

(51) Int. Cl. H04N 21/233; H04N 21/2368; H04N 21/4385; H04N 21/6334; H04N 21/2187; H04N 21/422; H04N 21/4223; H04N 21/2389; H04N 21/414

(52) U.S. Cl. CPC H04N 21/2335; H04N 21/23895; H04N 21/2368; H04N 21/43853; H04N 21/41407; H04N 21/2187; H04N 21/42203; H04N 21/4223; H04N 21/63345

(57) ABSTRACT

The present discloses an audio server that includes at least one memory device to store instructions and at least one processing device to execute the instructions stored in the least one memory device to convert audio sound waves from live event or concert into an audio signal, capture video of at least portions of the live event or the concert, generate an encoded stream by encrypting the audio signal and the captured video with a key, and in response to receiving purchase confirmation from a device, transmit the key to the device and stream the encoded stream to at least one device during the live event or concert. The device may decode the encoded stream using the key.

### CROSS REFERENCE TO RELATED APPLICATIONS

This application is a continuation-in-part and claims priority to U.S. non-provisional application Ser. No. 15/096,092, filed Apr. 11, 2016, which, in turn, claims priority to pending U.S. provisional patent application No. 62/148,002, filed Apr. 15, 2015, all of which is incorporated herein by reference in its entirety.

### TECHNICAL FIELD

The present disclosure relates to a system and method for transmitting digital audio streams to attendees at public events.

### BACKGROUND

Concerts provide an opportunity to see and hear artists perform live. Unfortunately, the audio broadcast at such concerts may be distorted, too loud, too quiet, over-amplified, or otherwise compromised by the acoustics of the venue. The artists often release high quality audio recordings of their concert performance for purchase. These recordings, however, are made available temporally distant from the actual performance.

### DRAWINGS DESCRIPTION

FIGS. 1A and 1B schematically illustrates a block diagram of an exemplary system for transmitting an audio stream to attendees at public events, accordance with some embodiments; and

FIG. 2 is a block diagram of an embodiment of a method 200 for transmitting an audio stream to attendees of a public event.

### DETAILED DESCRIPTION

It is desirable to transmit high quality audio streams at public events, such as music concerts, sporting matches, speeches, and the like to improve upon the listening experience for the attendee.

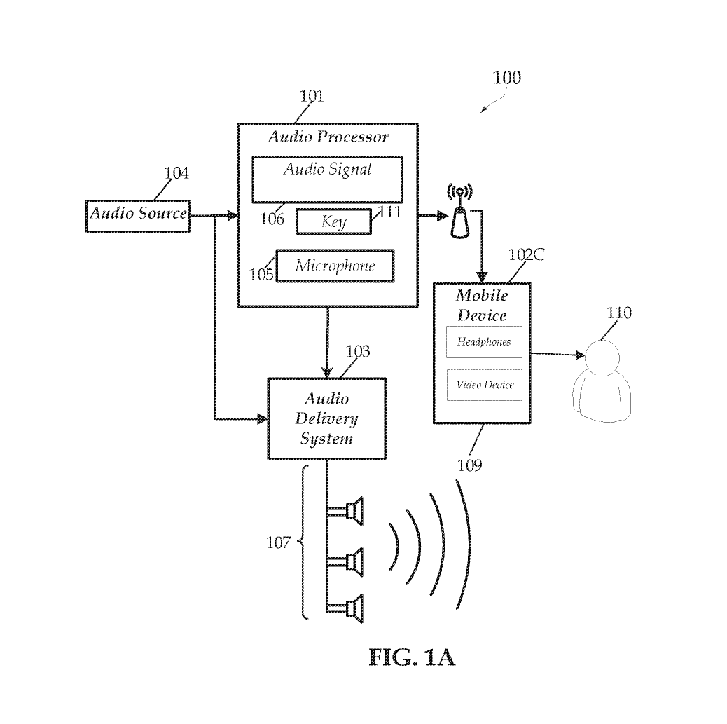

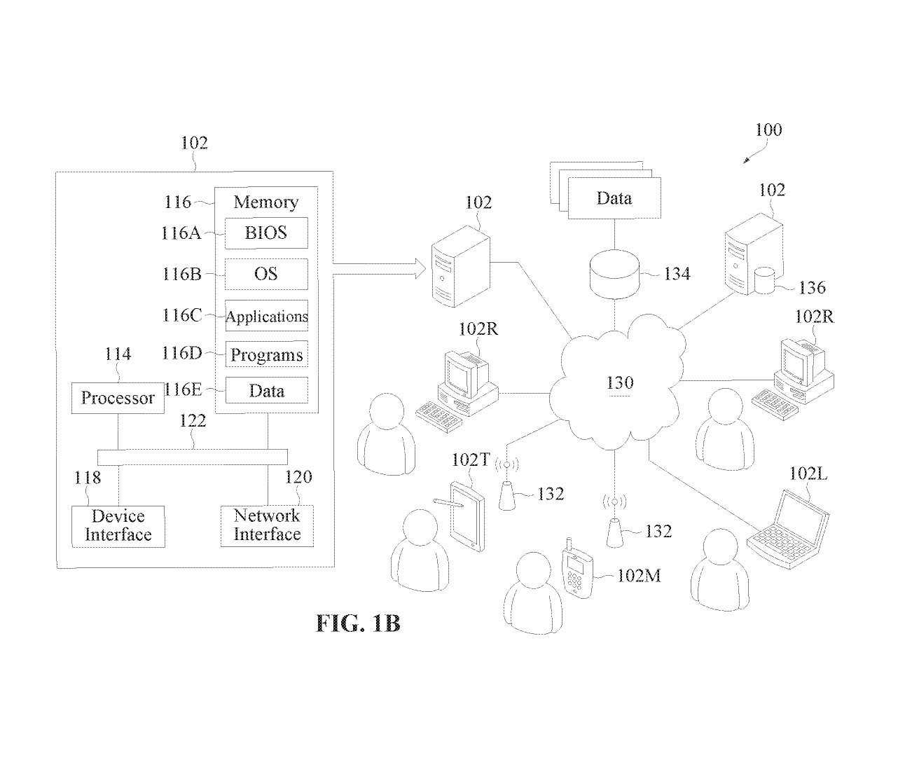

FIGS. 1A and 1B schematically illustrates a block diagram of an exemplary system for transmitting an audio stream to attendees at public events, accordance with some embodiments. Referring to FIG. 1A, system 100 includes an audio source 104 that generates sound waves from one or more performers or instruments. An audio processor 101 may include a microphone 105 that receives sound waves from audio source 104 and converts the sound waves to an audio signal 106. A person of ordinary skill in the art should recognize that audio processor 101 may be any electronic device capable of capturing and converting sound waves to electronic audio signal 106. In an embodiment, audio processor 101 may include a single microphone 105 to capture the sound waves produced by one or more performers or instruments represented as audio source 104. In an embodiment, audio processor 101 may include a plurality of microphones 105, each capturing the sound waves produced by a single performer or instrument in a group or plurality of performers or instruments. Further, audio processor 101 may convert the sound waves to one or more electronic signals in any form known to a person of ordinary skill in the art, e.g., analog or digital signals. Audio processor 101 may include mixing boards, sound processing equipment, amplifiers, and the like as is well known to a person of ordinary skill in the art.

Audio delivery system 103 may amplify and distribute audio signal 106 to attendees of a public or private event, e.g., meeting or concert. Audio delivery system 103 may include one or more speakers 107 as well as microphones and amplifiers (not shown) as is well known to a person of ordinary skill in the art. Audio delivery system 103 may include sound reinforcement systems that reproduce and distribute audio signal 106 or live sound from audio source 104. In some embodiments, audio delivery system 103 may reproduce and distribute sound to attendees through one subsystem termed “main” and to performers themselves though another subsystem termed “monitor.” At a concert or other event in which live sound reproduction is being used, sound engineers and technicians may control the mixing boards for the “main” and “monitor” subsystems, adjusting the tone, levels, and overall volume of the performance.

Audio processor 101 may filter and otherwise further process sound captured from audio source 104. In an embodiment, audio processor 101 may digitize, packetize, and/or encrypt audio signal 106.

In an embodiment, audio processor 101 may digitize audio signal 106 in a circumstance in which audio source 104 is initially captured as an analog signal. Audio processor 101 may digitize audio signal 106 using well known analog-to-digital converters (ADC) and technologies as is well known to a person of ordinary skill in the art.

In an embodiment, audio processor 101 may packetize audio signal 106 after conversion to a digital signal. Audio processor 101 may packetize digital audio signal 106 in any format known to a person of ordinary skill in the art, e.g., transmission control protocol/internet protocol (TCP/IP). Each packet may include a header and a body as is well known to a person of ordinary skill in the art.

In an embodiment, audio processor 101 may filter audio signal 106 to improve the quality of the audio generated therefrom. Audio processor 101 may filter audio signal 106 to remove extraneous noise, emphasize certain frequency ranges through the use of low-pass, high-pass, band-pass, or band-stop filters, change pitch, time stretch, emphasize certain harmonic frequency content on specified frequencies, attenuate or boost certain frequency bands to produce desired spectral characteristics, and the like as is well known to a person of ordinary skill in the art. Audio processor 101 may use predetermined settings stored in memory (not shown) or seek user input to determine filtering parameters. Audio processor 101 may filter audio signal 106 while still maintaining the characteristics of a live event.

In an embodiment, an attendee 110 may wish to experience the visual effects of the event as it unfolds live while listening to audio signal 106 using headphones 109. By doing so, attendee 110 may be better able to control the volume and other like attributes of the event while excluding extraneous noise from, e.g., neighboring or other attendees of such events. Attendee 110 may wish to have the ability to store a recording of the live event contemporaneous with the occurrence of the event rather than having to wait until the release of the live recording at a later time temporally distant from the live experience. Attendee 110 may purchase the rights to stream audio signal 106 using any mechanism known to a person of ordinary skill in the art, e.g., using a credit card. Attendee 110 may purchase the rights to stream audio signal 106 using device 102C that, in turn, may transmit confirmation of payment to audio processor 101. Attendee 110 may purchase the rights to stream audio signal 106 using any number of applications designed to operate on or in association with device 102C to accept payment for goods, e.g. square, apple pay, and the like. Attendee 110 may purchase the rights to stream the audio signal 106 at any time up to the end of the event, e.g., at a time of ticket purchase. Audio processor 101 may be receive confirmation of payment from device 102C that, in turn, may enable or trigger audio processor 101 to stream audio signal 106 to device 102C.

In an embodiment, audio processor 101 may encrypt audio signal 106 before transmission to, e.g., device 102C of attendee 110. Audio processor 101 may encrypt audio signal 106 to ensure that only authorized attendee 110 may decrypt, store, and ultimately listen to audio signal 106. Audio processor 101 may encrypt or otherwise encode audio signal 106 using any encryption algorithm or scheme known to a person of ordinary skill in the art, symmetric key schemes, public key encryption schemes, pretty good privacy, and the like. In an embodiment, audio processor 101 may provide device 102C with a key 111 to decrypt or decode audio signal 106 before or after transmission of audio signal 106 to device 102C. Audio processor 101 may transmit key 111 to device 102C separately from audio signal 106. Device 102C may ensure the integrity and authenticity of audio signal 106 using any known message verification technique, e.g., message authentication code (MAC), digital signature, and the like.

Once digitized, packetized, and/or encrypted, audio processor 101 may transmit the encoded audio packets using any known means, including IEEE standard 802.11 (WLAN) or the like. Users may listen to such a broadcast on a device 102C, e.g., mobile phone, smart phone, tablet, hand held computing device, or other computing device that has the capability to receive information transmitted wirelessly or otherwise by the audio processor 101.

In an embodiment, attendee 110 may perceive two audio streams during the live event or performance. The first audio stream may be broadcast via audio delivery system 103 through speakers 107. The first audio stream may be picked up or otherwise captured by a microphone (not shown) or other mechanism in device 102C. The second audio stream may be transmitted in packetized and/or encrypted form as audio signal 106 to device 102C. A software application that executes on device 102C may buffer and synchronize both the first and second audio streams (e.g., audio signal 106) so that the two audio streams, when played back for attendee 110 using device 102C, are experienced by attendee 110 as a single stream through devices such as headphones 109, e.g., earbuds, noise-cancelling headphones, and the like. By doing so, attendee 110 may perceive of little or no timing shift with improved quality over at least the first audio stream received without further processing through speakers 107 and audio delivery system 103.

Ethernet standards (IEEE 802.3), upon which the WLAN spec (IEEE 802.11) is based, define various modes of broadcast. The one most commonly used today is “point to point,” by which a sender's address and a receiver's address of digital data are uniquely specified in the header of each packet of, e.g., audio signal 106. Thus, only those two members within the local area network (LAN) are privy to that audio stream. Other multicast and broadcast addressing mechanisms also defined by those standards, whereby one sender is able to transmit data to multiple or every attendee within the LAN. Audio processor 101 may transmit audio signal 106 using the “broadcast” addressing mode such that every networked device 102C may be capable of receiving audio signal 106. Only those devices 102C that have the proper key may be capable of decrypting and thus, accessing audio signal 106. In an embodiment, device 102C or an application executing on device 102C, if authenticated, may automatically record and retain a digital copy of the event for later playback by the user. Device 102C may ensure authentication to allow access to audio signal 106 by any means known to a person of skill in the art. The additional charges for the transmission of audio signal 106 may enable additional revenue from the event.

In an embodiment, user 110 may record at least portions of the event using a video device included in mobile device 102C. The video device may be any device known to a person of ordinary skill in the art including a video camera and the like. The recorded video may be stored in any kind of memory, e.g., memory 116 shown in FIG. 1B. The recorded video may take advantage of the improvements afforded audio signal 106 by being able to combine audio signal 106 with the recorded video signal from device 102C in an encoded stream. Mobile device 102C may be able to record the video and combine the video with audio signal 105 in an encoded stream. Mobile device 102C may be able to upload the encoded stream, the recorded video, or audio signal 106 to any social media network, application, or the like. In an embodiment, mobile device 102C may be able to upload the recorded video and/or audio signal 106 using any known means, including network 130.

System 100 may offer attendee 110 several advantages over existing systems including a higher quality audio experience than that available through the first audio stream output from, e.g., speakers 107, custom control of the volume of audio signal 106 through local control afforded by device 102C, and an ability to store audio signal 106 at device 102C for reproduction and play after the end of the event.

System 100 may be implemented, at least in part, in any one or more of the computing devices shown in FIG. 1B. In an embodiment, audio processor 101 and device 102C may be implemented, at least in part, in any computing device 102 shown in FIG. 1B. Referring to FIG. 1B, system 100 may include a computing device 102 that may execute instructions defining components, objects, routines, programs, instructions, data structures, virtual machines, and the like that perform particular tasks or functions or that implement particular data types. Instructions may be stored in any computer-readable storage medium known to a person of ordinary skill in the art, e.g., system memory 116, remote memory 134, or external memory 136. Some or all of the programs may be instantiated at run time by one or more processors comprised in a processing unit, e.g., processing device 114. A person of ordinary skill in the art will recognize that many of the concepts associated with the exemplary embodiment of system 100 may be implemented as computer instructions, firmware, hardware, or software in any of a variety of computing architectures, e.g., computing device 102C, to achieve a same or equivalent result.

Moreover, a person of ordinary skill in the art will recognize that the exemplary embodiment of system 100 may be implemented on other types of computing architectures, e.g., general purpose or personal computers, hand-held devices, mobile communication devices, gaming devices, music devices, photographic devices, multi-processor systems, microprocessor-based or programmable consumer electronics, minicomputers, mainframe computers, application specific integrated circuits, and the like. For illustrative purposes only, system 100 is shown in FIG. 1A to include audio processor 101 that may be implemented in computing devices 102, geographically remote computing devices 102R, tablet computing device 102T, mobile computing device 102M, and laptop computing device 102L shown in FIG. 1B. Further, system 100 is shown in FIG. 1A to include a device 102C that may be implemented in any of devices 102 shown in FIG. 1B, e.g., tablet computing device 102T, mobile computing device 102M, or laptop computing device 102L. Mobile computing device 102M may include mobile cellular devices, mobile gaming devices, mobile reader devices, mobile photographic devices, and the like.

A person of ordinary skill in the art will recognize that an exemplary embodiment of system 100 may be implemented in a distributed computing system in which various computing entities or devices, often geographically remote from one another, e.g., computing device 102 and remote computing device 102R, perform particular tasks or execute particular objects, components, routines, programs, instructions, data structures, and the like. For example, the exemplary embodiment of system 100 may be implemented in a server/client configuration connected via network 130 (e.g., computing device 102 may operate as a server and remote computing device 102R or tablet computing device 102T may operate as a client, all connected through network 130). In distributed computing systems, application programs may be stored in and/or executed from local memory 116, external memory 136, or remote memory 134. Local memory 116, external memory 136, or remote memory 134 may be any kind of memory, volatile or non-volatile, removable or non-removable, known to a person of ordinary skill in the art including non-volatile memory, volatile memory, random access memory (RAM), flash memory, read only memory (ROM), ferroelectric RAM, magnetic storage devices, optical discs, or the like.

Computing device 102 may comprise processing device 114, memory 116, device interface 118, and network interface 120, which may all be interconnected through bus 122. The processing device 114 represents a single, central processing unit, or a plurality of processing units in a single or two or more computing devices 102, e.g., computing device 102 and remote computing device 102R. Local memory 116, as well as external memory 136 or remote memory 134, may be any type memory device known to a person of ordinary skill in the art including any combination of RAM, flash memory, ROM, ferroelectric RAM, magnetic storage devices, optical discs, and the like that is appropriate for the particular task. Local memory 116 may store a database, indexed or otherwise. Local memory 116 may store a basic input/output system (BIOS) 116A with routines executable by processing device 114 to transfer data, including data 116E, between the various elements of system 100. Local memory 116 also may store an operating system (OS) 116B executable by processing device 114 that, after being initially loaded by a boot program, manages other programs in the computing device 102. Memory 116 may store routines or programs executable by processing device 114, e.g., applications 116C or programs 116D. Applications 116C or programs 116D may make use of the OS 116B by making requests for services through a defined application program interface (API). Applications 116C or programs 116D may be used to enable the generation or creation of any application program designed to perform a specific function directly for a user or, in some cases, for another application program. Examples of application programs include word processors, calendars, spreadsheets, database programs, browsers, development tools, drawing, paint, and image editing programs, communication programs, tailored applications, and the like. Users may interact directly with computing device 102 through a user interface such as a command language or a user interface displayed on a monitor (not shown). Local memory 116 may be comprised in a processing unit, e.g., processing device 114.

Device interface 118 may be any one of several types of interfaces. Device interface 118 may operatively couple any of a variety of devices, e.g., hard disk drive, optical disk drive, magnetic disk drive, or the like, to the bus 122. Device interface 118 may represent either one interface or various distinct interfaces, each specially constructed to support the particular device that it interfaces to the bus 122. Device interface 118 may additionally interface input or output devices utilized by a user to provide direction to the computing device 102 and to receive information from the computing device 102. These input or output devices may include voice recognition devices, gesture recognition devices, touch recognition devices, keyboards, monitors, mice, pointing devices, speakers, stylus, microphone, joystick, game pad, satellite dish, printer, scanner, camera, video equipment, modem, monitor, and the like (not shown). Device interface 118 may be a serial interface, parallel port, game port, firewire port, universal serial bus, or the like.

A person of ordinary skill in the art will recognize that the system 100 may use any type of computer readable medium accessible by a computer, such as magnetic cassettes, flash memory cards, compact discs (CDs), digital video disks (DVDs), cartridges, RAM, ROM, flash memory, magnetic disc drives, optical disc drives, and the like. A computer readable medium as described herein includes any manner of computer program product, computer storage, machine readable storage, or the like.

Network interface 120 operatively couples the computing device 102 to one or more remote computing devices 102R, tablet computing devices 102T, mobile computing devices 102M, and laptop computing devices 102L, on a local, wide, or global area network 130. Computing devices 102R may be geographically remote from computing device 102. Remote computing device 102R may have the structure of computing device 102 and may operate as server, client, router, switch, peer device, network node, or other networked device and typically includes some or all of the elements of computing device 102. Computing device 102 may connect to network 130 through a network interface or adapter included in the network interface 120. Computing device 102 may connect to network 130 through a modem or other communications device included in the network interface 120. Computing device 102 alternatively may connect to network 130 using a wireless device 132. The modem or communications device may establish communications to remote computing devices 102R through global communications network 130. A person of ordinary skill in the art will recognize that applications 116C or programs 116D might be stored remotely through such networked connections. Network 130 may be local, wide, global, or otherwise and may include wired or wireless connections employing electrical, optical, electromagnetic, acoustic, or other carriers as is known to a person of ordinary skill in the art.

The present disclosure may describe some portions of the exemplary system 100 using algorithms and symbolic representations of operations on data bits within a memory, e.g., memory 116. A person of ordinary skill in the art will understand these algorithms and symbolic representations as most effectively conveying the substance of their work to others of ordinary skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated by physical devices, e.g., computing device 102. For simplicity, the present disclosure refers to these physical signals as bits, values, elements, symbols, characters, terms, numbers, or like. The terms are merely convenient labels. A person of ordinary skill in the art will recognize that terms such as computing, calculating, generating, loading, determining, displaying, or like refer to the actions and processes of a computing device, e.g., computing device 102. The computing device 102 may manipulate and transform data represented as physical electronic quantities within a memory into other data similarly represented as physical electronic quantities within the memory.

In an embodiment, system 100 may be a distributed network in which some computing devices 102 operate as servers, e.g., computing device 102, to provide content, services, or the like, through network 130 to other computing devices operating as clients, e.g., remote computing device 102R, laptop computing device 102L, tablet computing device 102T. In some circumstances, distributed networks use highly accurate traffic routing systems to route clients to their closest service nodes.

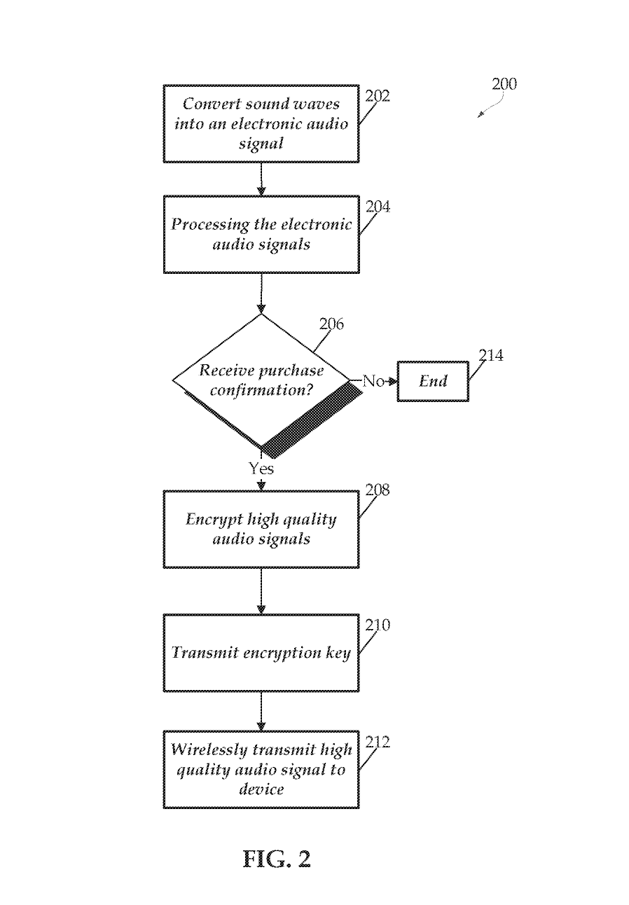

FIG. 2 is a block diagram of an embodiment of a method 200 for transmitting an audio stream to attendees of a public event. Referring to FIGS. 1A and 2, at 202, method 200 includes converting sound waves from an audio source 102 into audio signal 106. At 204, method 200 includes optionally processing the electronic audio signal by, e.g., digitizing, filtering, or both digitizing and filtering, audio signal 106. At 206, method 200 may determine whether it has received purchase confirmation from a device, e.g., device 102C. If not, method 200 may end at 214 without making available audio signal 106. If method 200 receives purchase confirmation, method 200 may encrypt audio signal 106 at 208 using any algorithm or scheme known to a person of ordinary skill in the art. At 210, method 200 may transmit encryption key 111 to device 102C using any means known to a person of ordinary skill in the art, e.g., wireless transmission. At 212, method 200 may transmit audio signal 106 to device 102C that may, in turn, use encryption key 111 to decrypt audio signal 106 for storing or otherwise playing.

Persons of ordinary skill in the art will appreciate that the present disclosure is not limited to what has been particularly shown and described hereinabove. Rather, the scope of the present disclosure includes both combinations and sub-combinations of the various features described hereinabove as well as modifications and variations which would occur to such skilled persons upon reading the foregoing description. Thus the disclosure is limited only by the appended claims.

1. An audio server, comprising:
at least one memory device to store instructions; and
at least one processing device to execute the instructions stored in the least one memory device to:
convert audio sound waves from live event or concert into an audio signal;
capture video of at least portions of the live event;
generate an encoded stream by encrypting the audio signal and the video with a key; and
in response to receiving purchase confirmation from a device:
transmit the key to the device; and
stream the encoded stream to at least one device during the live event or concert;
wherein the device decodes the encoded stream using the key.

2. The audio server of claim 1, wherein the at least one processing device executes the instructions stored in the at least one memory device further to:
packetize the audio signal into packetized digital audio.

3. The audio server of claim 1, wherein the at least one processing device executes the instructions stored in the at least one memory device further to:
convert a plurality of audio sound waves originating at a plurality of audio sources into a corresponding plurality of audio signals; and
combine the plurality of audio signals into a single audio signal.

4. The audio server of claim 1, wherein the at least one processing device executes the instructions stored in the at least one memory device further to:
capture the audio sound waves; and
stream the encoded stream to the device substantially contemporaneously with capture of the audio sound waves or the capture of the video.

5. The audio server of claim 1, wherein the at least one processing device executes the instructions stored in the at least one memory device further to:
filter the audio signal to generate a filtered audio signal by filtering out noise.

6. The audio server of claim 1, wherein the at least one processing device executes the instructions stored in the at least one memory device further to:
generate a packetized encoded stream by encrypting the encoded stream using the IEEE standard 802.11; and
stream the packetized encoded stream.

7. The audio server of claim 1, wherein the at least one processing device executes the instructions stored in the at least one memory device further to:
filter the audio signal to generate a filtered audio signal having an audio quality higher than that of the audio signal.

8. An audio system, comprising:
at least one microphone to capture sound waves emanating from at least one sound source during a live event or concert;
a video device to capture video of at least portions of the live event or the concert;
an audio processor to:
convert the captured sound waves into an audio signal;
filter the audio signal to generate a filtered audio signal having an audio quality higher than that of the audio signal;
generate an encoded stream by encrypting the filtered audio signal and the video with a key; and
stream the encoded stream to at least one device substantially contemporaneous with the at least one microphone capturing the sound waves emanating from the least one sound source;
wherein the encoded stream is decoded using the key.

9. The audio system of claim 8, wherein the audio processor is further configured to packetize the filtered digital audio into packetized digital audio.

10. The audio system of claim 8, wherein the audio processor is further configured to:
convert a plurality of audio sound waves originating at a plurality of audio sources into a corresponding plurality of audio signals; and
combine the plurality of audio signals into a single audio signal.

11. The audio system of claim 8, wherein the audio processor is further configured to:
capture the audio sound waves; and
stream the encoded stream to the at least one device substantially contemporaneously with capture of the audio sound waves.

12. The audio system of claim 8, wherein the audio processor is further configured to:
filter the audio signal to generate a filtered audio signal by filtering out noise.

13. The audio system of claim 8, wherein the audio processor is further configured to:
generate a packetized encoded stream by encrypting the filtered audio signal using the IEEE standard 802.11; and
stream the packetized encoded stream to the at least one device.

14. A method, comprising:
capturing sound waves emanating from at least one audio source;
converting the captured sound waves into an audio signal;
capturing video from a live event;
generating an encoded stream by encrypting the audio signal and the video with a key;
providing the key to at least one device in response to receiving payment confirmation from least one device; and
streaming the encoded stream to the at least one device substantially contemporaneous with the at least one microphone capturing the sound waves emanating from the least one audio source;
wherein the encoded stream is decoded using the key.

15. The method of claim 14, further comprising:
packetizing the audio signal into packetized digital audio.

16. The method of claim 14, further comprising:
converting a plurality of audio sound waves originating at a plurality of audio sources into a corresponding plurality of audio signals; and
combining the plurality of audio signals into a single audio signal.

17. The method of claim 14, further comprising:
streaming the encoded stream to the at least one device substantially contemporaneously with the capturing of the sound waves.

18. The method of claim 14, further comprising:
filtering the audio signal to generate a filtered audio signal by filtering out noise.

19. The method of claim 18, further comprising:
generating a packetized encoded stream by encrypting the filtered audio signal using the IEEE standard 802.11; and
streaming the packetized encoded stream to the at least one device.
